(19) United States
(12) Patent Application Publication
(10) Pub. No.: US 2009/0094014 A1
(43) Pub. Date: Apr. 9, 2009

(54) Software System For Binding Model Data To View Components

(76) Inventor: Wynne Crisman, Colorado Springs, CO (US)

Correspondence Address: DECLARATIVE ENGINEERING, LLC, 232 CUSTAR AVE., COLORADO SPRINGS, CO, 80903, US

(21) Appl. No.: 11/867,201

(22) Filed: Oct. 4, 2007

(51) Int. Cl. G06F 17/50

(52) U.S. Cl. 703/16

(57) ABSTRACT

A flexible method of mapping view components to data model objects in an object oriented system. The mapping manages navigating the data model graph to access data needed by the view component and to listen for events indicating changes within the data model graph and relevant to the view component. This mapping is extremely flexible in that the component can elect to receive one result for one input, one result for each of many inputs, multiple results for one input, or multiple results for each of multiple inputs, and the association used in the mapping internalizes the event management required for keeping the component up to date with the latest changes in the mapped data model.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

The present invention is related to mapping between a view and an object model through the use of an association. The association handles registering, unregistering, and handling events indicating a change in the value, getting and setting the value, and notifying association listeners when values get altered. The mapping allows for one to one, one to many, and many to many relationships between the component's input into the association and the result of the association.

Mapping between data sets has always been a time consuming and code intensive problem normally solved by writing a lot of situation specific code. This solution can be expensive both to write initially and then to maintain, and it is very prone to error. It is also rare that the data flow is bidirectional due to the immense complexity of event registration and handling data flow correctly.

Another method commonly used in view systems to interact with the data model is to pass the view components implementations of component defined interfaces. The idea is to separate the logic for view data transfer into manageable chunks, making the system a bit easier to maintain, but doing little to reduce the mapping code or ease the complexity of setting up listeners and managing data flow.

### BRIEF SUMMARY OF THE INVENTION

In accordance with the present invention, associations are defined and fleshed out to map data to a view system. A view component will define an association holder and an interface for the user to provide an association container that encapsulates the association metadata. The view component will then pass the association holder an input value and receive an output value that will be used by the component.

The component can define the association holder as being single, multi, variable, or collecting. A single association is one that results in a single output for a single input. A multi association holder results in a single output for each input, of which there may be zero or more. A variable association holder is one that can behave as a single or as a multi association based on the metadata provided by the user. The collecting association holder is one that results in a collection of results for each input provided.

The association container that is passed to the association holder via the component interface simply abstracts the structure of the association tree that is the metadata used to access the correct data in the model when the view requests it. The association tree can use one of two forms, a dynamic tree, or a static tree. A dynamic tree defines a list of association nodes provided in the order searched and the first match is navigated to generate a result. The dynamic tree is iterative such that each result generated may be re-inserted to refine the result. The static tree defines a list of association nodes similar to the dynamic tree, but each association node may have child association nodes which are provided with the result of the parent until an end node results in the final result for the association container. Each association node is capable of managing event hooks that receive notification when the data model is altered such that the view system is always displaying the latest model state. The association nodes may also be navigated to set the data in the model data set if it is altered by the view component.

This association system greatly simplifies the mapping between the model and view data sets and provides reliable notification when the targeted model data changes. It allows changes in the view to be propagated to the correct place in the model data set without incurring unnecessary feedback loops. The system also provides flexibility to handle the various use cases of one to one, one to many, and many to many, and to allow complex mappings in data sets that are dynamically changing.

### BRIEF DESCRIPTION OF THE DRAWING

FIG. 1 depicts the relationship between the component, association, and data model at a very high level.

FIG. 2 is an object interaction diagram showing a single association interacting with a more detailed depiction of the data model.

FIG. 3 is an object interaction diagram similar to FIG. 2, but showing how the component can pass in multiple row objects for a multi association.

FIG. 4 is a class diagram depicting the relationships between the classes that make up the association system.

FIG. 5 is a class diagram depicting the detailed structure of the association node.

FIG. 6 is an object interaction diagram showing the memory state of a view component utilizing a single association to obtain model data.

FIG. 7 is an object interaction diagram showing the memory state of a view component utilizing a multi association to obtain model data.

FIG. 8 is an object interaction diagram showing the memory state of a view component utilizing a collecting single association to obtain model data.

FIG. 9 is a sequence diagram that demonstrates the setup of an association container.

FIG. 10 is a sequence diagram showing how the component accesses the association's result.

FIG. 11 is a sequence diagram showing how the component sets the result after modifying it.

### DETAILED DESCRIPTION OF THE INVENTION

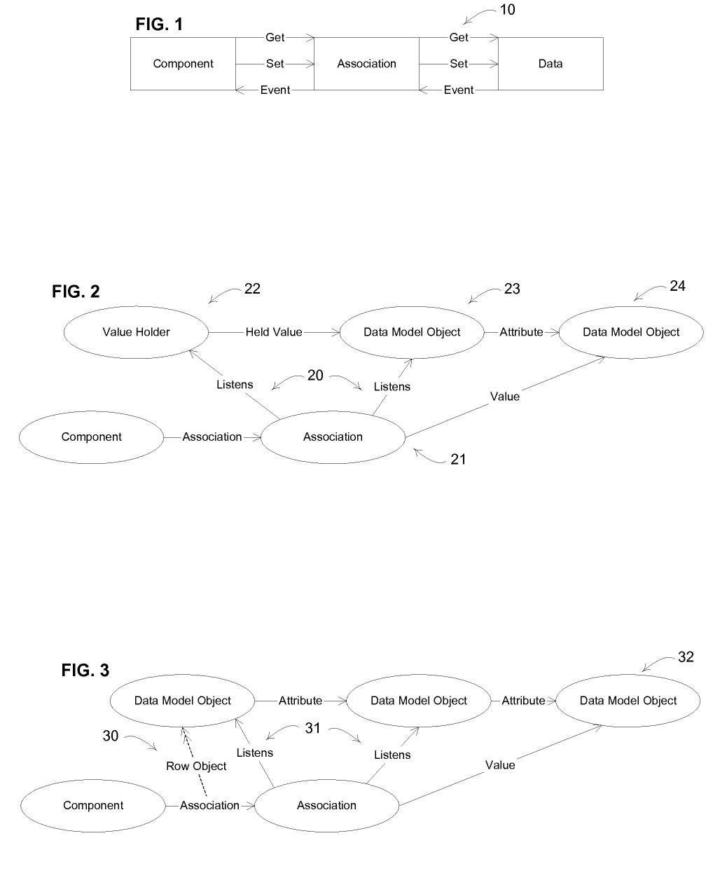

Referring to FIG. 1, the component refers to an association made up of the association holder, container, and metadata, mapping the component to the data model 10 which provides the component get and set access to the required parts of the model data, as well as model change notification. FIG. 2 shows more detail on how the association may need to interact with multiple objects 20 in the data model in order to access the value 24 required by the component. The value holder 22 in this depiction is a view construct that refers to a single value provided ultimately by the view initialization. When the value holder changes the value it references 23, or the held value changes its attribute value 24, the association re-evaluates the resulting value and notifies the component. FIG. 3 extends this to handle components which require a result for zero or more input model objects that we will call row objects 30. The association listens to 31 each data model object in the chain up to the result value, and obtains a result value 32 for each row object.

FIG. 4 depicts basic the class structure for the association code. There are several different types of associations possible 40. Single and collecting single association containers reference a value holder from which the input value is obtained. Multi and collecting multi association containers are provided row objects by the component, usually the result of a collecting single association. The association holder 41 in this picture is simplified, but also has the same variety as the containers 40. The association container references one or more association nodes 42 which are used to generate a result for an input by navigating one attribute or getter method within the data model. Each association node references a class 43 which is the type of input required by the association node. The container determines which association node in the set to use based on whether the input object's class is a, or extends the class referenced by the association node. Note that collecting associations will pass the input to all defined association nodes whose class match the input value and will collect the results of each association node.

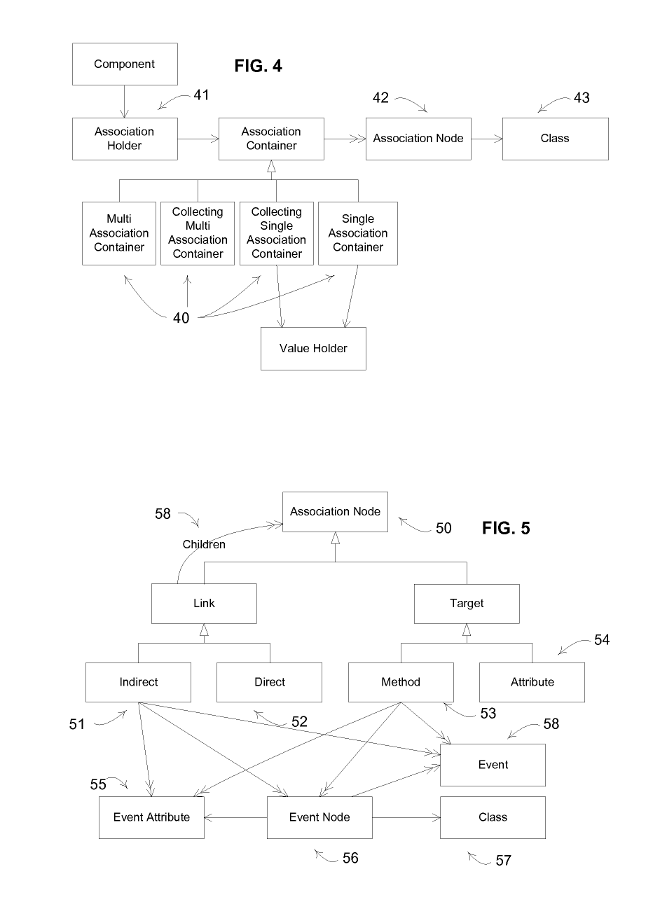

In FIG. 5 we show the details of the association node. An association node can be a link association whose result is used as input back into the association set, or target associations whose result is passed back to the component as a value to be used in the view system. Link associations can also reference child association nodes 58 which is usable to provide a different set of association node from the one referenced by the association container. Link association nodes can be further divided into indirect link association nodes 51 which use getter and optional setter methods to access the result from the model, and direct link association nodes 52 which use an attribute defined by the input to access the association's result. Target association nodes can also be divided into method target association nodes 53 which, just like indirect link association nodes, will access their result via a getter and an optional setter method, and attribute target association nodes 54 which use an attribute defined by the input to access the result. Indirect 51 and method 53 association nodes may optionally define a dynamic tree of events to be listened to for change notification. To provide maximum flexibility, the indirect or method association nodes can define events 58 on the association node input to listen to, event attributes 55 on the association node input whose values are passed as input to event nodes 56. Event nodes may define additional events 58 to listen to on the passed event node input, and they may define event attributes 55 whose referenced value is passed to the event nodes 56 referenced by the indirect or method association node. Which event nodes 56 are passed input from an event attribute 55 is determined by matching the event attribute's value with the event node's referenced class 57 such that the event attribute's value is a or extends the class.

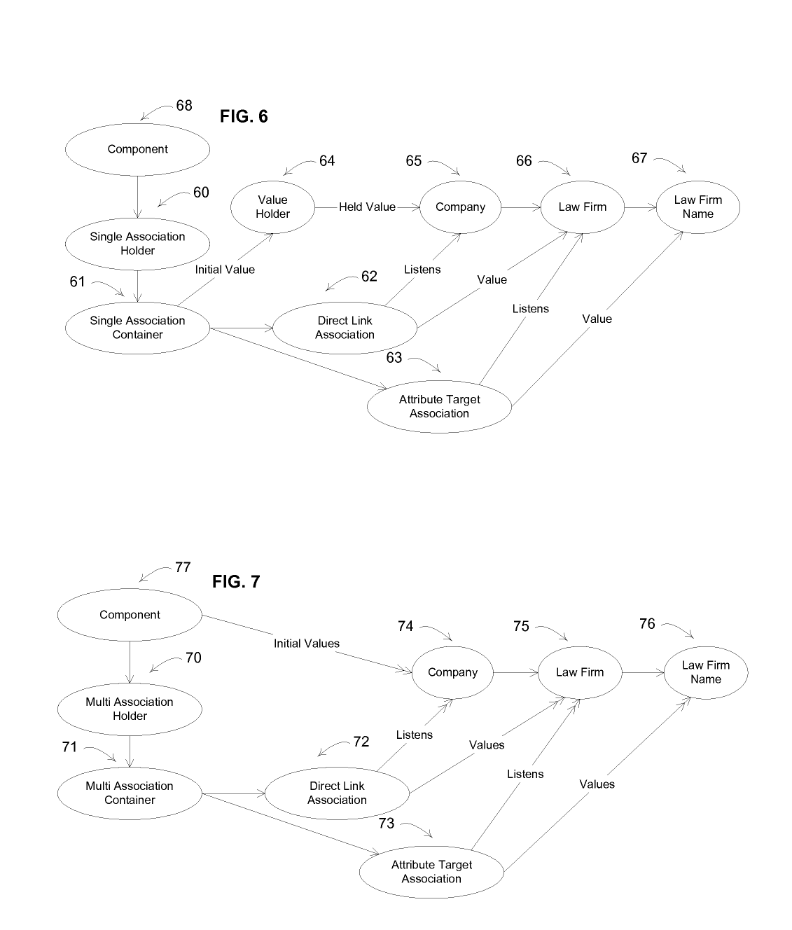

FIG. 6 is an object interaction diagram showing a simplified memory state for a view component 68 that is accessing a company's 65 law firm's 66 law firm name 67. Here the component defines a single association holder 60 which has been assigned a single association container 61 that gets its initial input value from a value holder 64. The value holder's held value 65 is accessed by the single association container and is matched with the direct link association 62 which accesses the law firm object 66 and listens for changes in the company's attribute (that is used to reference the law firm object). The law firm object is used by the single association container as input to the attribute target association which obtains the result law firm name object 67 and listens for changes in the law firm object.

FIG. 7 is similar to FIG. 6 in many regards, but here we are accessing a law firm name 76 for each company 74 held by the view component 77. The component 77 uses a multi association holder 70 which is provided a multi association container 71. The component passes the initial company values 74 which are used by the container 71 to pass into the direct link association 72 which obtains the law firm 75 as a result for each passed company, and listens to each company 74 for changes in it's law firm attribute. Each result of the direct link association 72 is passed as input to the attribute target association 73 which listens for changes in the law firm's law firm name attribute and provides the container with the law firm name 76 as its result. In this example the view component could very well be displaying the law firm name for each company in a list or table.

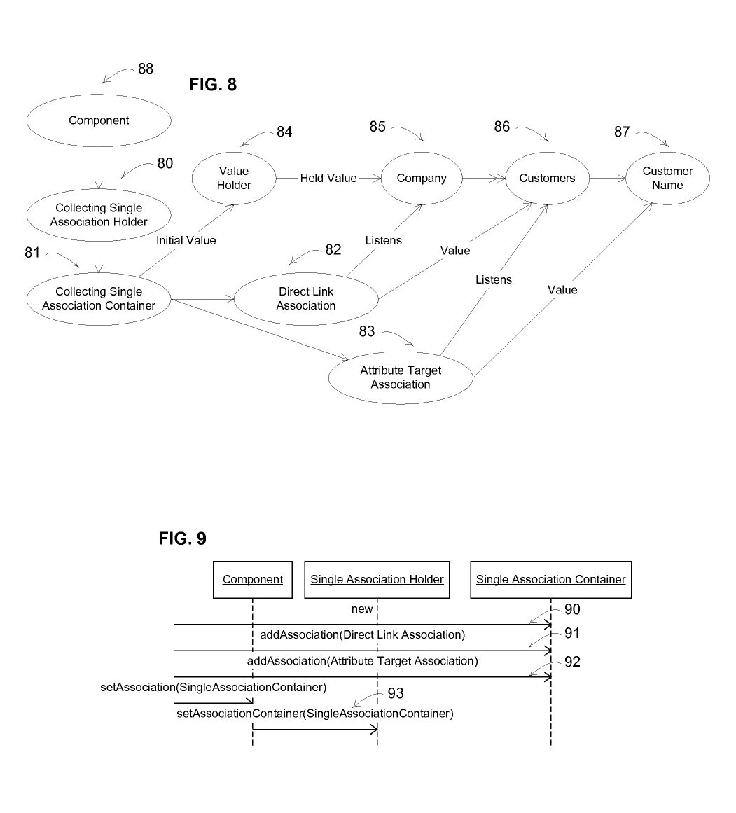

In FIG. 8 we demonstrate the use of the collecting single association to obtain a collection of customer names 87 for a company 85. Here the component 88 defines a collecting single association holder 80 which is provided a collecting single association container 81 with two association nodes defined and a value holder 84 which provides the initial company 51 value. The direct link association 82 is passed the company 85 as the input and provides the collection of customers 86 as the output which the container passes to the attribute target association 83 as input. The attribute target association sets up listeners on each customer 86 passed as input, and obtains the customer name 87 for each customer input as the result.

FIG. 9 depicts the creation of the single association container shown in FIG. 6. The user code first creates a new single association container 90. The user code then adds to the single association container 91 a direct link association that was initialized passing the company class and the company class's law firm attribute. An attribute target association is then created with the law firm class and the law firm name attribute and provided to the single association 92. Finally the user code tells the component to set the association which passes the message to the single association holder 93.

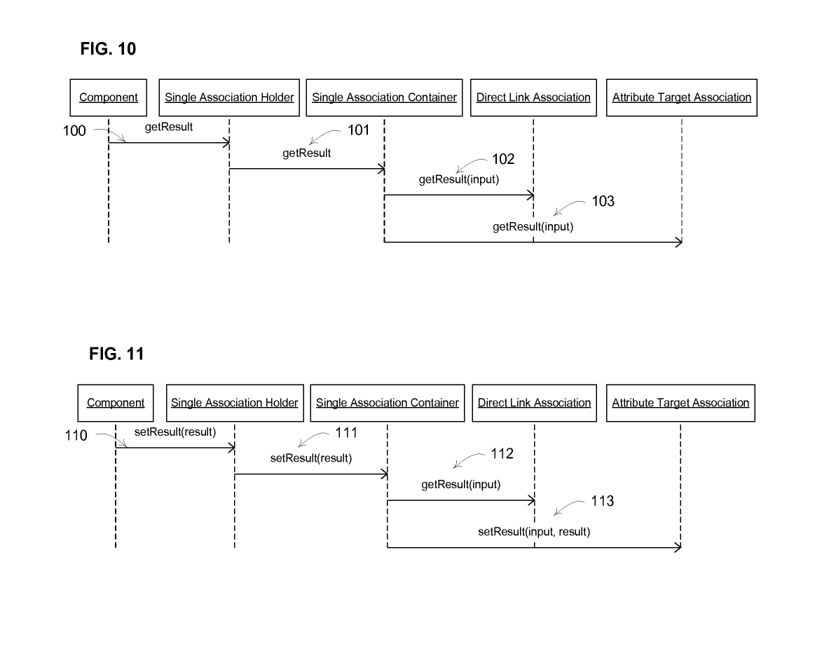

FIG. 10 shows how a result is retrieved by the component using the objects shown in FIG. 6. The component first calls the single association holder 100 to get the result, which in turn passes the message to the single association container 101. The container might cache the result if it has previously retrieved it, but otherwise it must first get the result from the direct link association 102, passing the value holder's held value as the input. Then the direct link association's result will be passed to the attribute target association 103 whose result is then passed all the way back to the component.

In FIG. 11 we demonstrate how the same objects in FIG. 10 and 6 are used to save the value modified by the component back to the model data. The component sets the result 110 in the single association holder, which passes it to the single association container 111. The container might cache the ending association and the input to that association, otherwise it will need to find it by getting the result 112 of the direct link association, passing the value holder's held value as input. Once the target association node has been identified, the result can be set 113, passing the result of the direct link association as the input and the component's new value as the result. The attribute target association will then call the input object's setter method to set the value.

What is claimed is:

1. A method for bi-directional mapping (association) between a view component and the data model in an object oriented computer language on a computer readable medium and adapted to operate on a computer such that the view component accesses data from the model, listens to the model for changes, refreshes when changes occur, and synchronizes changes in the view component back to the model, all via the association, where the association is defined by its type: one output for one input, N outputs for one input, N outputs for N inputs, or M outputs for N inputs, and the association is provided: an input model which is either a row value from a collection view component, or a value holder that will reference a model value at runtime, an input type if not accessible from the value holder or collection view component, an attribute defined by the input model which is used to get and set the value and listen for changes or a getter method and optional setter method and optional event structure consisting of events, attributes, and event nodes that consist of a node type, node events, and node attributes, where each attribute's value in the input model is passed to the event nodes that, if the attribute value and the node type match, will listen on the node events for the input attribute value and access the node attribute's values from the input attribute value, each of which will then be re-inserted into the set of event nodes held by the association.
